(19) United States
(12) Patent Application Publication
(10) Pub. No.: US 2021/0148543 A1
(43) Pub. Date: May 20, 2021

(54) LAMP AND MINING LAMP

(71) Applicant: SHENZHEN ZHONGFUNENG ELECTRIC EQUIPMENT CO., LTD., Shenzhen, Guangdong (CN)

(72) Inventors: Baiping DING, Shenzhen (CN); Yangbiao HUANG, Shenzhen (CN); Yunyuan Li, Shenzhen (CN)

(73) Assignee: Shenzhen Zhongfuneng Electric Equipment Co., Ltd., Shenzhen, Guangdong (CN)

(21) Appl. No.: 17/043,776

(22) PCT Filed: Nov. 22, 2018
(86) PCT No.: PCT/CN2018/116884

§ 371 Date: Sep. 30, 2020

(30) Foreign Application Priority Data
Mar. 30, 2018 (CN) 201810294518.9

(51) Int. Cl. F21V 7/04; F21V 7/00; F21V 23/00

(52) U.S. Cl. CPC F21V 7/048; F21S 9/02; F21V 23/003; F21V 7/0075

(57) ABSTRACT

Disclosed are a lamp and a mining lamp The lamp includes a reflector, which is a spherical or bowl-shaped structure, an inner wall of the reflector is provided with a plurality of reflective layers in a honeycomb or scaly shape, each of the plurality of reflective layers includes a row of reflective surfaces arranged in the honeycomb or scaly shape, and all the rows of reflective surfaces are of surface reflection.

### CROSS-REFERENCE TO RELATED APPLICATIONS

This application is a National Stage Application, filed under 35 U.S.C. 371 of International Patent Application number PCT/CN2018/116884, filed on Nov. 22, 2018, which claims priority of Chinese patent application No. 201810294518.9 filed on Mar. 30, 2018, disclosure of which is incorporated herein by reference in its entirety.

### TECHNICAL FIELD

The present disclosure relates to the technical field of lighting equipment, for example, to a lamp and a mining lamp.

### BACKGROUND

A light emitting diode (LED) light source is used in a mining lamp. When an LED lamp is used as the light source of a downlight, the service life and luminous efficiency of the light source can be significantly improved, but glare is easily caused due to the concentrated light beam and the small irradiation area of the LED lamp.

At present, reflectors used in the mining lamp are all integrally smooth reflective mirror surfaces, this kind of mirror surface generates a light-focusing effect on the light emitted by the mining lamp, but the light emitted is uneven and the light spot generated is small, which brings fatigue influence on people's eyes. Especially in a working environment under the mine, the light-focusing effect and the small light spot generated by the light emitted by the mining lamp will bring inconvenience to the miners in their work.

### SUMMARY

The present disclosure provides a lamp and a mining lamp, so as to solve problems of a small irradiation area, uneven light emission and generating a light-focusing effect of the related mining lamp.

In one embodiment, the present disclosure provides a lamp including a reflector. The reflector is a spherical or bowl-shaped structure, an inner wall of the reflector is provided with a plurality of reflective layers in a honeycomb or scaly shape, each of the plurality of reflective layers includes a row of reflective surfaces arranged in the honeycomb or scaly shape, and all the rows of reflective surfaces are of surface reflection.

In one embodiment, a shape of each of the reflective surfaces is a polygon.

In one embodiment, the lamp further includes a lamp housing. The lamp housing includes a first lamp housing and a second lamp housing, and the reflector is detachably disposed inside the first lamp housing.

In one embodiment, the first lamp housing is provided with a protrusion, the second lamp housing is provided with a groove, and the first lamp housing is fixedly disposed on the second lamp housing through a plug-in fit between the protrusion and the groove.

In one embodiment, the protrusion and the groove are fixed by glue, a screw or a buckle.

In one embodiment, at least one mounting hole is disposed in the first lamp housing, at least one first positioning hole is disposed at a first end of the reflector, and the at least one mounting hole is fixed to the at least one first positioning hole through a connecting piece.

In one embodiment, a circuit board is disposed in the second lamp housing, at least one second positioning hole is disposed on the circuit board, at least one positioning post is disposed at a second end of the reflector, and the at least one positioning post is fixed in the at least one second positioning hole.

In one embodiment, the lamp further includes a battery connected to a light emitting diode (LED) light source through the circuit board.

In one embodiment, a number of reflective surfaces in each of the plurality of reflective layers is the same.

In one embodiment, a number of reflective surfaces in each of the plurality of reflective layers is not the same.

In one embodiment, the present disclosure further provides a mining lamp, the mining lamp includes the lamp and an LED light source, and the LED light source is disposed on a recessed portion of a reflector of the lamp.

In one embodiment, distances from all reflective surfaces in a same reflective layer of the lamp to the LED light source are the same.

### BRIEF DESCRIPTION OF DRAWINGS

FIG. 1A is a structure view of a mining lamp according to an embodiment of the present disclosure;

FIG. 1B is a partial structure view of a lamp according to an embodiment of the present disclosure;

FIG. 1C is a partial structure view of the lamp from a first angle according to an embodiment of the present disclosure;

FIG. 1D is a top view of a partial structure of the mining lamp according to an embodiment of the present disclosure;

FIG. 2 is an exploded view of FIG. 1A;

FIG. 3 is a partial section view at position A of FIG. 1A, and

FIG. 4 is an exploded view of another mining lamp according to an embodiment of the present disclosure.

### REFERENCE LIST

1 reflector

11 first positioning hole

12 positioning post

2 LED light source

21 circuit board

22 second positioning hole

3 lamp housing

31 first lamp housing

32 second lamp housing

33 battery

311 protrusion

321 groove

322 glue

41 lampshade

42 transparent mirror surface

43 sealing ring

44 lamp cap housing

45 cable

46 battery compartment

### DETAILED DESCRIPTION

The solutions of the present disclosure will be described below in conjunction with the drawings and embodiments.

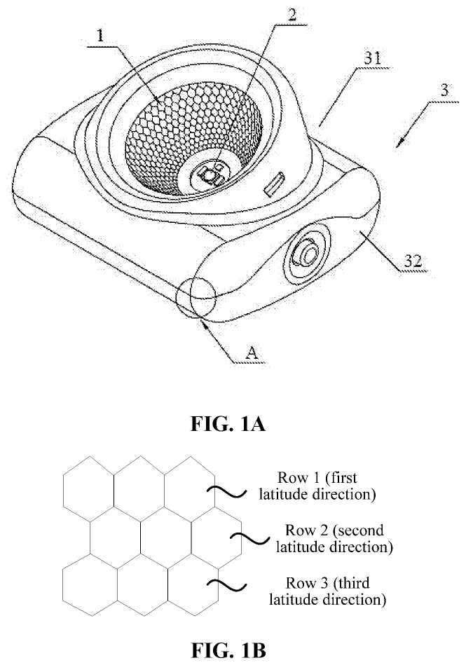

As shown in FIG. 1A, the present disclosure provides a mining lamp with large light spot effect, and the mining lamp includes a reflector 1, an LED light source 2, and a lamp housing 3.

The LED light source 2 is mounted on a recessed portion of the reflector 1 (for a bowl-shaped structure, the recessed portion is a bottom of an inner wall of the reflector 1; and for a spherical structure, the recessed portion is a bottom or a top of an inner wall of the reflector 1, and the top or bottom is determined only by the angle of view), the lamp housing 3 includes a first lamp housing 31 and a second lamp housing 32, the reflector 1 is detachably mounted inside the first lamp housing 31, and the first lamp housing 31 is mounted on the second lamp housing 32.

In one embodiment, the present disclosure further provides a lamp including a reflector 1, which may be a spherical or bowl-shaped structure. In one embodiment, the reflector 1 is the spherical structure. An inner wall of the reflector 1 is provided with a plurality of reflective layers distributed in a honeycomb or scaly shape, each of the plurality of reflective layers includes a row of reflective surfaces arranged in the honeycomb or scaly shape, and all the rows of reflective surfaces are of surface reflections. In one embodiment, all the reflective surfaces may be processed as mirror surfaces (that is, all the reflective surfaces are of specular reflection). In one embodiment, the number of reflective surfaces of each of the plurality of reflective layers is the same, or the number of reflective surfaces of each of the plurality of reflective layers may be not the same. Whether the number of reflective surfaces of each of the plurality of reflective layers is the same is determined according to the actual application situation. The effect of large irradiation area and even light emission can be achieved according to the mining lamp provided by the embodiment of the present disclosure.

In one embodiment, the present disclosure configures that the number of each row of reflective surfaces in the honeycomb or scaly reflective layer is the same, such that beam angles of the light emitted by the LED light source 2 after being reflected by the honeycomb reflective surface on the inner wall of the reflector 1 are the same, enlarging an irradiation range and generating a relatively soft large light spot effect, thereby enabling people to work under the light with a comfortable feeling. The reflective surface is processed as the mirror surface, such that light irradiated to the processed surface by the LED light source 2 is subjected to directional specular reflection instead of diffuse reflection, thereby achieving even light mixing. Moreover, this processing has advantages of small light energy loss, high reflective light efficiency, controllable direction of reflective light and high utilization rate of light source.

In one embodiment, distances from all reflective surfaces of each of the plurality of reflective layers to the LED light source are the same. In one embodiment, the honeycomb reflective surface of each layer is placed at a corresponding position after amplifying the honeycomb reflective surface by a certain magnification according to a parabola, such that the number of honeycomb reflective surfaces of each layer can be ensured to be the same.

In one embodiment, distances from all reflective surfaces of a same reflective layer of the lamp to the LED light source 2 are not the same.

In one embodiment, the shape of the reflective surface is a polygon, such as a hexagon, octagon, or rhombus. In one embodiment, as long as the shape of the reflective surfaces satisfy that the number of reflective surfaces in each layer of the reflective layer is the same, the shape of the reflective surface may be taken as the shape the reflective surface of the present disclosure. In one embodiment, the shape of the reflective surfaces arranged in the honeycomb shape is the hexagon.

In one embodiment, as shown in FIG. 1B, FIG. 1B is a partial structure view of a lamp according to an embodiment of the present disclosure, the shape of the reflective surface being the hexagon is described as an example, and one row of reflective surfaces may be understood as a plurality of reflective surfaces arranged in one latitude direction (not limited to three reflective surfaces in the figure). In FIG. 1B, partial reflective surfaces of a first latitude direction, partial reflective surfaces of a second latitude direction, and partial reflective surfaces of a third latitude direction are using as an example to respectively represent a first row of reflective surfaces, a second row of reflective surfaces, and a third row of reflective surfaces. The above-mentioned three rows of reflective surfaces, but not limited to the three rows of reflective surfaces, constitute a plurality of rows of reflective surfaces arranged in the honeycomb shape, and may be understood as that the reflective surfaces are respectively arranged in a plurality of latitude directions, each of the plurality of reflective layers includes a plurality of reflective surfaces, and the plurality of rows of reflective surfaces constitute the honeycomb shape as a whole.

FIG. 10 is a partial structure view of the lamp from a first angle according to an embodiment of the present disclosure. Referring to FIG. 10, in one embodiment, at least one first positioning hole 11 is disposed at a first end of the reflector 1, and the reflector 1 is fixed on the lamp housing 3 through the at least one first positioning hole 11. FIG. 1D is a top view of a partial structure of the mining lamp according to an embodiment of the present disclosure. Referring to FIG. 1D, the LED light source is disposed in a center of a recessed portion of the reflector 1.

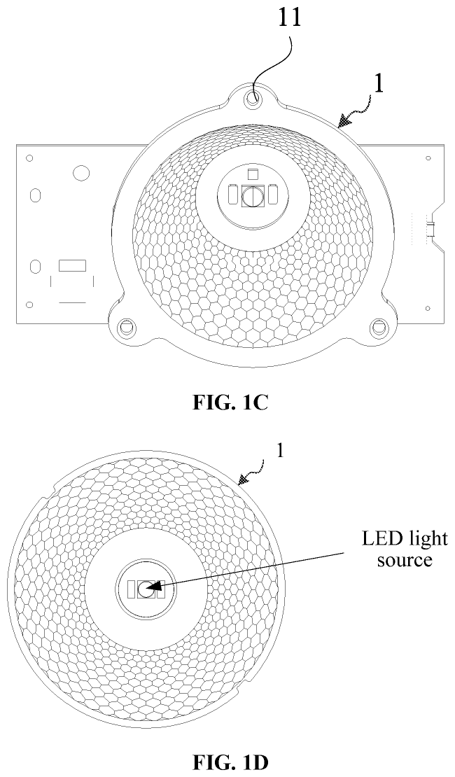

As shown in FIG. 2, the first lamp housing 31 is provided with a protrusion 311, the second lamp housing 32 is provided with a groove 321, and the first lamp housing 31 is fixedly disposed on the second lamp housing 32 through a plug-in fit between the protrusion 311 and the groove 3. Such configuration can ensure that the assembly of the lamp housing 3 is more convenient and cost-saving.

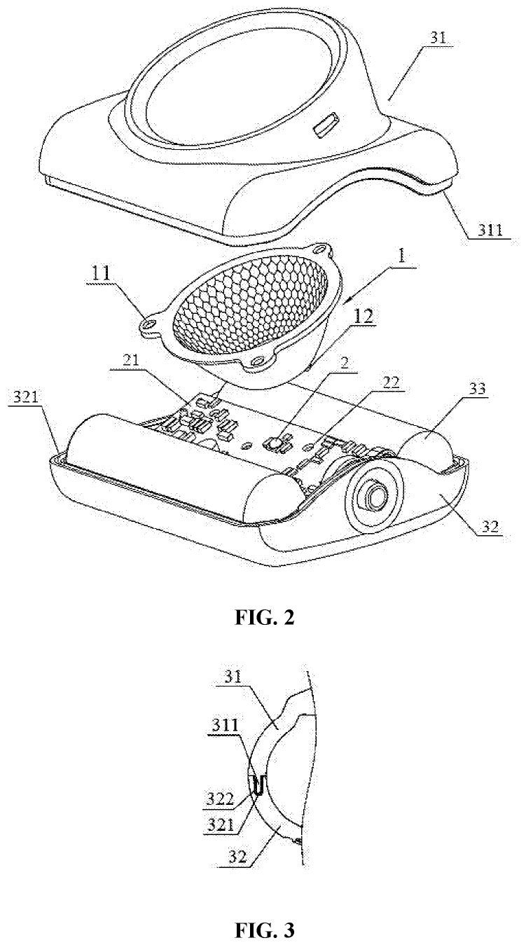

As shown in FIG. 3, in order to better connect the first lamp housing 31 to the second lamp housing 32, glue 322 is filled between the protrusion 311 and the groove 321, such that the first lamp housing 31 and the second lamp housing 32 can be fixed more tightly.

In one embodiment, the first lamp housing 31 and the second lamp housing 32 may be fixed by a screw or a buckle.

Continue to refer to FIG. 2, at least one mounting hole (not shown in the figure) is disposed in the first lamp housing 31, at least one first positioning hole 11 is disposed at the first end of the reflector 1, and the at least one mounting hole is fixed to the at least one first positioning hole 11 through a connecting piece. In one embodiment, the connecting piece may be a bolt or a fixing post.

In one embodiment, the number of mounting holes is the same as the number of first positioning holes 11.

In one embodiment, a circuit board 21 is disposed in the second lamp housing 32, at least one second positioning hole 22 is disposed on the circuit board 21, at least one positioning post 12 is disposed at a second end of the reflector 1, and the at least one positioning post 12 is fixed in the at least one second positioning hole 22. Due to a top end and a bottom end of the reflector 1 are fixed to the first lamp housing 31 and the second lamp housing 32, respectively, the reflector 1 can be ensured to be more stable.

In one embodiment, the number of positioning posts 12 is the same as the number of second positioning holes 22.

In one embodiment, the first end of the reflector 1 may be understood as one end far away from the recessed portion of the reflector 1, and the second end of the reflector 1 may be understood as one end close to the recessed portion of the reflector 1

In one embodiment, the first end of the reflector 1 is provided with at least one first positioning hole 11, and the circuit board 21 is not provided with the second positioning hole 22, that is, the position of the reflector 1 can be fixed only through the first positioning hole 11.

In one embodiment, the circuit board 21 is provided with at least one second positioning hole 22, and the first end of the reflector 1 is not provided with the first positioning hole 11, that is, the position of the reflector 1 can be fixed only through the second positioning hole 22.

In one embodiment, the first end of the reflector 1 is provided with at least one first positioning hole 11, and the circuit board 21 is provided with at least one second positioning hole 22, that is, the position of the reflector 1 can be fixed through the first positioning hole 11 and the second positioning hole 22.

In one embodiment, the lamp further includes a battery 33 connected to the LED light source 2 through the circuit board 21. The battery 33 can be directly introduced alternating current mains supply or a low-voltage power supply to supply power to the LED light source 2 in a constant current, such that the light emission is stable, stroboflash will not occur, and near infrared rays and ultraviolet rays are not included.

In one embodiment, the lamp provided by the present disclosure may further incorporate other lighting sources such as bulbs or fluorescent lamps. The lamp provided by the present disclosure is not limited being applied to the mining lamp, but may also be used in a variety of application scenarios such as hanging lamps, wall lamps, pendant lamps, ceiling lights, down lights, or project lamps.

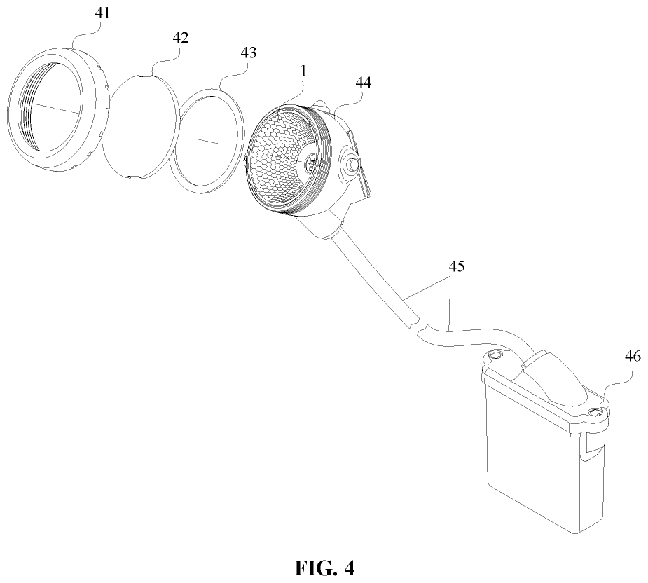

FIG. 4 is an exploded view of another mining lamp according to an embodiment of the present disclosure. In one embodiment, a lampshade 41, a transparent mirror surface 42 and a sealing ring 43 are disposed on the reflector 1 sequentially, and the reflector 1 is fixedly mounted on a lamp cap housing 44. In one embodiment, the reflector 1 may be fixedly mounted on the lamp cap housing 44 by screws. The mining lamp is connected to a battery compartment 46 through a cable 45, and the battery compartment 46 is configured to supply power for a light source of the mining lamp. A length of the cable 45 may be set according to the actual reference, and the length of the cable 45 is not limited in FIG. 4. The cable 45 is continuous, and only a cross section of the cable 45 is shown in FIG. 4, which does not represent that the cable 45 is broken.

In the present disclosure, the light beam angles of the light emitted by the LED light source after being reflected by the reflective surfaces on the inner wall of the reflector are the same, which enlarges the irradiation range and generates the relatively soft large light spot effect, thereby enabling people to work under the light with a comfortable feeling. The light from the LED light source irradiated to the processed surface is subjected to the directional surface reflection, thereby achieving the effect of uniform light mixing. Moreover, this processing has advantages of small light energy loss, high reflective light efficiency, controllable direction of reflective light and high utilization rate of light source.

1. A lamp, comprising a reflector; wherein the reflector is a spherical or bowl-shaped structure, an inner wall of the reflector is provided with a plurality of reflective layers in a honeycomb or scaly shape, each of the plurality of reflective layers comprises a row of reflective surfaces arranged in the honeycomb or scaly shape, and all the rows of reflective surfaces are of surface reflection.

2. The lamp of claim 1, wherein a shape of each of the reflective surfaces is a polygon.

3. The lamp of claim 1, further comprising a lamp housing, wherein the lamp housing comprises a first lamp housing and a second lamp housing, and the reflector is detachably disposed inside the first lamp housing.

4. The lamp of claim 3, wherein the first lamp housing is provided with a protrusion, the second lamp housing is provided with a groove, and the first lamp housing is fixedly disposed on the second lamp housing through a plug-in fit between the protrusion and the groove.

5. The lamp of claim 4, wherein the protrusion and the groove are fixed by glue, a screw or a buckle.

6. The lamp of claim 4, wherein at least one mounting hole is disposed in the first lamp housing, at least one first positioning hole is disposed at a first end of the reflector, and the at least one mounting hole is fixed to the at least one first positioning hole through a connecting piece.

7. The lamp of claim 4, wherein a circuit board is disposed in the second lamp housing, at least one second positioning hole is disposed on the circuit board, at least one positioning post is disposed at a second end of the reflector, and the at least one positioning post is fixed in the at least one second positioning hole.

8. The lamp of claim 6, further comprising a battery connected to a light emitting diode (LED) light source through a circuit board.

9. The lamp of claim 1, wherein a number of reflective surfaces in each of the plurality of reflective layers is the same.

10. The lamp of claim 1, wherein a number of reflective surfaces in each of the of plurality of reflective layers is not the same.

11. A mining lamp, comprising the lamp of claim 1 and a light emitting diode (LED) light source, wherein the LED light source is disposed on a recessed portion of a reflector of the lamp.

12. The mining lamp of claim 11, wherein distances from all reflective surfaces in a same reflective layer of the lamp to the LED light source are the same.

13. The lamp of claim 2, further comprising a lamp housing, wherein the lamp housing comprises a first lamp housing and a second lamp housing, and the reflector is detachably disposed inside the first lamp housing.

14. The lamp of claim 6, wherein a circuit board is disposed in the second lamp housing, at least one second positioning hole is disposed on the circuit board, at least one positioning post is disposed at a second end of the reflector, and the at least one positioning post is fixed in the at least one second positioning hole.

15. The lamp of claim 7, further comprising a battery connected to a light emitting diode (LED) light source through the circuit board.

16. A mining lamp, comprising the lamp of claim 2 and an LED light source, wherein the LED light source is disposed on a recessed portion of a reflector of the lamp.

17. A mining lamp, comprising the lamp of claim 3 and an LED light source, wherein the LED light source is disposed on a recessed portion of a reflector of the lamp.

18. A mining lamp, comprising the lamp of claim 4 and an LED light source, wherein the LED light source is disposed on a recessed portion of a reflector of the lamp.

19. A mining lamp, comprising the lamp of claim 5 and an LED light source, wherein the LED light source is disposed on a recessed portion of a reflector of the lamp.

20. A mining lamp, comprising the lamp of claim 6 and an LED light source, wherein the LED light source is disposed on a recessed portion of a reflector of the lamp.
